(19) United States
(12) Patent Application Publication
(10) Pub. No.: US 2025/0199211 A1
(43) Pub. Date: Jun. 19, 2025

(54) LIGHT DIFFUSER

(71) Applicant: Kohler Co., Kohler, WI (US)

(72) Inventor: Douglas J. Diemel, JR., Kohler, WI (US)

(21) Appl. No.: 18/975,877

(22) Filed: Dec. 10, 2024

Related U.S. Application Data
(60) Provisional application No. 63/610,140, filed on Dec. 14, 2023.

(51) Int. Cl. G02B 5/02; F21V 3/04; F21Y 105/14; F21Y 115/10; G02B 5/08

(52) U.S. Cl. CPC G02B 5/0242; F21V 3/049; G02B 5/0289; G02B 5/0294; G02B 5/0816; F21Y 2105/14; F21Y 2115/10

(57) ABSTRACT

A mirror assembly includes mirrored glass, at least one frosted edge disposed along a side of the mirrored glass, a diffuser disposed behind the at least one frosted edge, the diffuser including a plurality of refractive particles suspended in a substrate, and a light source configured to generate light. The plurality of reflective particles may refract light generated by the light source and the refracted light may travel through the at least one frosted edge.

### CROSS-REFERENCE TO RELATED APPLICATION

This application claims priority benefit of Provisional Application No. 63/610,140 (Docket No. 010222-23048A) filed on Dec. 14, 2023, which is hereby incorporated by reference in its entirety.

### FIELD

The present disclosure relates generally to mirrors. More specifically, the present disclosure relates to lighted mirrors.

### BACKGROUND

Generally, lighted mirrors may include a diffuser configured to scatter or soften light before light is directed toward a user. Methods of manufacturing a lighted mirror including a diffuser are burdensome and costly. Generally, a diffuser must be cut to size from a slab or sheet of transparent or semi-transparent material (e.g., plastic, acrylic). After being cut, one or more processes, for example, chemical etching, laser etching, are performed to form abrasions in the diffuser configured to scatter or refract light. Finally, after the abrasions have been formed, the diffuser must be attached of fixed to the other components of the lighted mirror. Accordingly, there is a need for lighted mirrors that are easier to manufacture and improved methods of manufacturing the same.

### BRIEF DESCRIPTION OF THE DRAWINGS

Objects, features, and advantages of the present disclosure should become more apparent upon reading the following detailed description in conjunction with the drawing figures, in which:

FIG. 1 illustrates a lighted mirror assembly in accordance with one example of the present disclosure.

FIG. 2 illustrates a lighted mirror assembly in accordance with another example of the present disclosure.

FIG. 3 illustrates a lighted mirror assembly in accordance with another example of the present disclosure.

FIG. 4 illustrates a lighted mirror assembly in accordance with another example of the present disclosure.

FIG. 5 illustrates a lighted mirror assembly in accordance with another example of the present disclosure.

FIG. 6 illustrates a cross sectional view of the lighted mirror assembly of FIG. 1 taken along section line AA of FIG. 1.

FIG. 7 illustrates a rear view of the mirror assembly of FIG. 1 in accordance with an example of the present disclosure.

FIG. 8 illustrates a rear view of the mirror assembly of FIG. 2 in accordance with one example of the present disclosure.

FIG. 9 illustrates a cross sectional view of a lighted mirror assembly in accordance with another example of the present disclosure.

FIG. 10 illustrates a cross sectional view of a lighted mirror assembly performing primary lighting in accordance with one example of the present disclosure.

FIG. 11 illustrates a cross sectional view of a lighted mirror assembly performing primary lighting and secondary lighting in accordance with one example of the present disclosure.

FIG. 12 illustrates a system for controlling a lighted mirror assembly in accordance with one example of the present disclosure.

FIG. 13 illustrates an apparatus for controlling a lighted mirror assembly in accordance with one example of the present disclosure.

FIG. 14 illustrates a method of manufacturing a lighted mirror assembly in accordance with one example of the present disclosure.

The figures illustrate certain examples of the present disclosure in detail. It should be understood that the present disclosure is not limited to the details and methodology set forth in the detailed description or illustrated in the figures. It should be understood that the terminology used herein is for the purposes of description only and should not be regarded as limiting.

### DETAILED DESCRIPTION

Described herein are lighted mirrors (e.g., lighted mirror assemblies) and methods of manufacturing lighted mirrors. Specifically, described herein are lighted mirrors including a diffuser configured to diffuse (e.g., scatter, soften) light generated by a light source and methods of manufacturing the same. In some examples, the diffuser may be disposed behind a transparent or semi-transparent frosted edge of the mirrored surface (e.g., mirrored glass) and may be configured to diffuse light generated by the light source. The diffused light may then travel through the frosted edge (e.g., toward a user). In some examples, the diffuser may include a plurality of refractive particles configured to refract light traveling through the diffuser. The refractive particles may comprise micro-glass beads, hollow glass microspheres, or the like. The refractive particles may diffuse the light generated by the light source, hiding the light source and eliminating “hot” or bright spots of light associated with the light source and visible through the frosted edge. Additionally, in some examples, the refractive particles may glow when illuminated, creating a unique aesthetic visible through the frosted edge.

In some examples, a method of manufacturing a lighted mirror according to an example of the present disclosure includes pour molding a resinous material to form a diffuser. Specifically, in some examples, a resinous material may be pour molded into a mold or basin comprised of a bracket coupled to a back of a mirrored surface, a mirrored surface, a frosted edge, and a frame disposed along an exterior boundary of the frosted edge. In some examples, a plurality of refractive particles may be mixed into the resinous material before the resinous material is pour molded such that the refractive particles are suspended in the diffuser when the resinous material has cured. In some examples, the frame may include one or more locking features (e.g., locking protrusions) configured to control a position of the frame, the mirrored surface, and the frosted edge relative to the diffuser. In some examples, the resinous material may be poured around the one or more locking features, and when the resinous material has cured into the diffuser, the one or more locking features may control a position of the frame, the mirrored surface, and the frosted edge relative to the diffuser. In some examples, one or more locking features may include a reflective surface configured to reflect light toward the frosted edge.

In some examples, the resinous material may be poured around a light source, for example, a light emitting diode (LED), and or a printed circuit board (PCB) coupled to the bracket. Accordingly, the resinous material may encapsulate the light source and PCB, advantageously protecting the light source and PCB from moisture and preventing the light source and PCB from shifting during transportation of the lighted mirror.

In some examples, the mirror assemblies described herein may include a mirrored surface and one or more frosted edges. Each of the frosted edges may be disposed along an edge or side of the mirrored surface and may be comprised of a transparent or semi-transparent materials. In some examples, the frosted edge may be a transparent or semi-transparent portion of the mirrored surface in which a reflective coating (e.g., silver, aluminum coating) of the mirrored surface has been removed. In some examples, a frosted edge or frosted edges may be disposed along a perimeter of the mirrored surface. In some examples, frosted edges may be disposed along two or more (e.g., opposite) edges of the mirrored surface. The mirror assemblies may further include a light source configured to generate light and a diffuser configured to diffuse light generated by the light source. Light diffused by the diffuser may travel through the frosted edge of the mirror assembly (e.g., toward a user). In some examples, two or more sides of a mirrored surface may include a light source, diffuser, and frosted edge such that light generated by a light source on two or more sides of the mirrored surface may be directed toward a user.

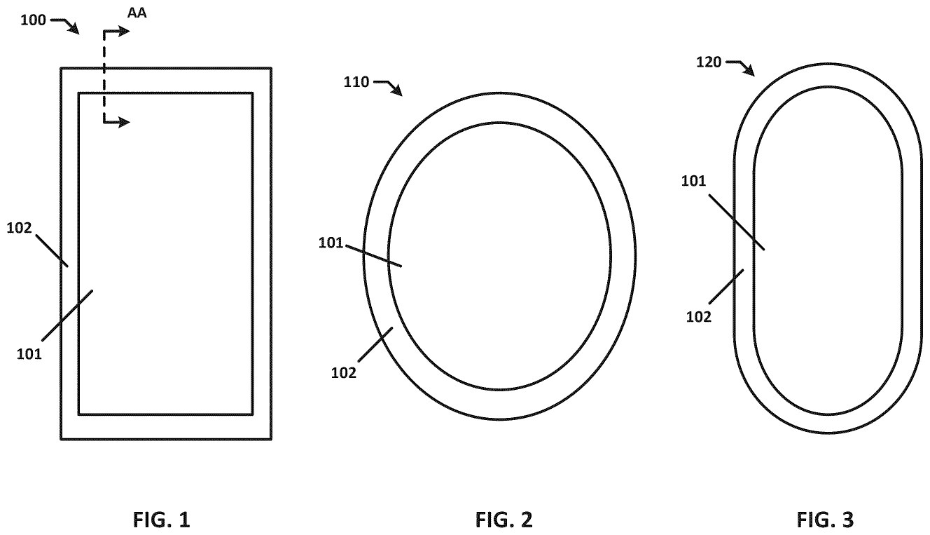

Referring generally to FIGS. 1-5, a plurality of mirror assemblies 100, 110, 120, 130, 140 according to examples of the present disclosure are illustrated. Each of the mirror assemblies 100, 110, 120, 130, 140 may include a mirrored surface 101 (e.g., mirrored glass) and one or more frosted edges 102. The mirrored surface may be comprised of a reflective coating applied to glass sheet. For example, the mirrored surface 101 may be comprised of a silver or aluminum coating applied to a glass sheet. In some examples, the mirrored surface 101 and the frosted edge(s) 102 of the mirror assembly may be integrally formed. Specifically, the frosted edge(s) 102 may be an acid etched, sand-blasted, or laser etched portion of the mirrored surface 101 in which a reflective coating (e.g., on a back of the mirrored surface) is removed leaving behind a transparent or semi-transparent glass sheet comprising the frosted edge 102. According to other examples, the frosted edge(s) 102 may be a portion of a glass sheet to which no reflective coating is applied and the mirrored surface 101 may be a portion of the glass sheet to which a reflective coating is applied. The frosted edge 102 may be semi-transparent (e.g., semi-clear) such that light (e.g., produced by a light source included in the mirror assembly) may travel through the frosted edge(s) 102. Each of the mirrored surface 101 and the frosted edge(s) 102 may form a portion of a front surface of the mirror assembly 100, 110, 120, 130, 140.

As described in greater detail below, each of the mirror assemblies 100, 110, 120, 130, 140 may include a diffuser configured to refract or scatter (e.g., diffuse, disperse) light generated by one or more light sources. Specifically, the diffuser may be configured to scatter or soften light generated by the one or more light sources such that a more even or uniform light travels through the frosted edge(s) (e.g., toward a user). The diffuser may be configured to refract light generated by the one or more light sources, spreading the light rays in various directions, and creating a more evenly distributed illumination. In some examples, the diffuser may include one or more refractive particles configured to further refract light traveling through the diffuser. In some examples, the diffuser may further include one or more abrasions or micro indentations formed therein and configured to further refract light traveling through the diffuser. Light refracted by the diffuser may travel through the one or more frosted edges 102 of the mirror assembly 100, 110, 120, 130, 140 (e.g., toward a user). In some examples, the diffuser may be disposed adjacent to and directly behind frosted edges 102. For example, the diffuser may extend behind the frosted edges 102 along a length of the frosted edges 102.

In some examples, a mirror assembly 100, 110, 120, 130, 140 according to the present disclosure may be disposed in a bathroom. For example, the mirror assembly may be disposed above a vanity, above a sink (and/or faucet), and the like. In other examples, a mirror assembly 100, 110, 120, 130, 140 according to the present disclosure may be used in a different setting, for example, in a salon, healthcare facility, or the like. However, the present disclosure is not limited thereto and a mirror assembly 100, 110, 120, 130, 140 according to the present disclosure may be used in any setting and/or for any application.

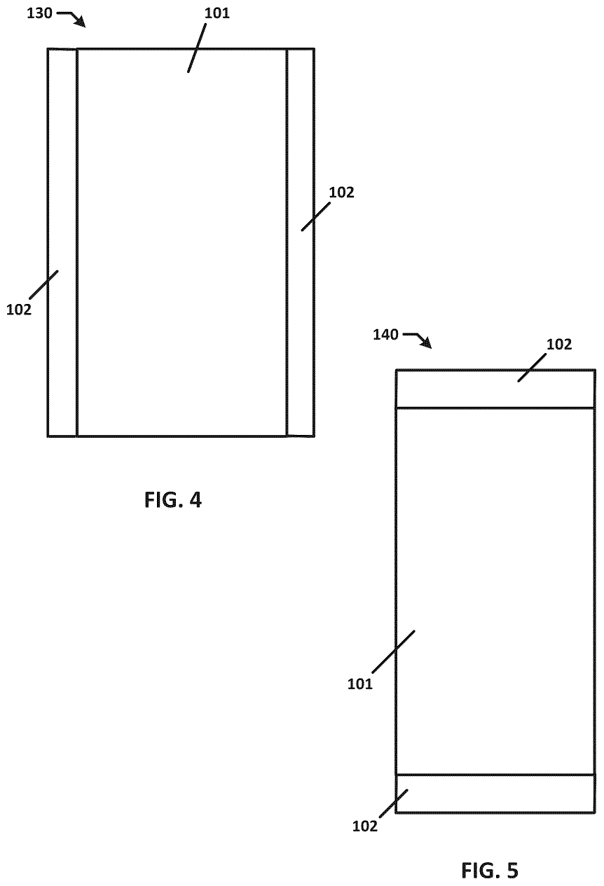

As illustrated in FIGS. 1-5, the size and/or shape of the mirrored surface 101 (e.g., mirrored glass) and the frosted edges 102 included in each of the mirror assemblies 100, 110, 120, 130, 140 may vary. In some examples, as illustrated in FIGS. 1, 4, and 5, the mirror assembly 100, 130, 140 may include a mirrored surface 101 (e.g., mirrored glass) having a rectangular shape. For example, the mirror assembly 100, 130, 140 may include a rectangular sheet or panel of mirrored glass. In other examples, the mirrored surface 101 may have another polygonal shape, for example, a pentagon or hexagon shape. In some examples, the one or more frosted edges 102 of the mirror assembly 100, 130, 140 may be linear. Specifically, when the mirrored surface 101 has a polygon shape, the frosted edges 102 may be linear. In some examples, as illustrated in FIG. 1, the mirror assembly 100 may include four frosted edges 102. In some examples, all sides of a polygon shaped mirrored surface 101 may include frosted edges 102. In other examples, as illustrated in FIGS. 4 and 5, the mirror assembly 130, 140 may only include two frosted edges 102. For example, as illustrated in FIGS. 4 and 5, opposite sides of a rectangular mirrored surface 101 may include frosted edges 102. As illustrated in FIG. 4, a left and right (e.g., first and second) side of a rectangular mirrored surface 101 may include frosted edges 102. As illustrated in FIG. 5, a top and bottom (e.g., third and fourth) side of a rectangular mirrored surface may include frosted edges 102. Additional or fewer frosted edges 102 are possible for example, a mirror assembly may include a single frosted edge 102, three frosted edges 102, or more than four frosted edges 102. In some examples, the number of frosted edges 102 included in a mirror assembly may correspond to a number of sides of the mirrored surface 101.

In some examples, as illustrated in FIG. 2, the mirror assembly 120 may include a mirrored surface 101 (e.g., mirrored glass) having a circular shape. For example, the mirror assembly 110 may include a circular panel or sheet of mirrored glass. In other examples, the mirrored surface 101 may include another rounded shape, such as an ellipsoid or another shape. In some examples, for example, when the mirrored surface 101 has a circular shape, the one or more frosted edges 102 may be curved. For example, as illustrated in FIG. 2, the mirror assembly 110 may include a single frosted edge 102 circumscribing the circular mirrored surface 101. In other examples, the mirror assembly 110 may include one or more frosted edges 102 disposed around a portion or portions of the circular mirrored surface 101. For example, the frosted edges 102 may be spaced at regular or irregular intervals.

In other examples, as illustrated in FIG. 3, the mirror assembly 120 may include a mirrored surface 101 (e.g., mirrored glass) having an oblong or a pill shape. For example, the mirror assembly 120 may include an oblong or pill shaped panel or sheet of mirrored glass. Specifically, as illustrated in FIG. 3, the mirrored surface 101 may have a shape including both linear and curved sides. In some examples, when the mirrored surface 101 that includes both linear and curved sides, the mirror assembly 120 may include both linear and curved frosted edges 102. Specifically, linear sides of the mirrored surface 101 may have linear frosted edges 102 and curved sides of the mirrored surface 101 may have curved frosted edges 102. As illustrated in FIG. 3, all of the sides of the mirrored surface 101 include a frosted edge 102; however, the present disclosure is not limited thereto. For example, only one set of opposite sides (e.g., top and bottom, left and right) may include frosted edges 102. In other examples, three sides or only a single side of the mirrored surface 101 may include frosted edges 102.

In some examples, each of the frosted edges 102 may have the same thickness. In some examples, each of the frosted edges may have a consistent thickness (e.g., along their entire length). As described herein, the thickness of a linear frosted edge 102 or a curved frosted edge 102 included in a pill shaped mirror (e.g., mirrored surface 101 and frosted edges 102) may be a length of the frosted edge 102 extending in a direction between opposite frosted edges 102. The thickness of a frosted edge 102 of a circular mirror (e.g., mirrored surface 101 and frosted edge 102) may be a radial length of the frosted edge 102.

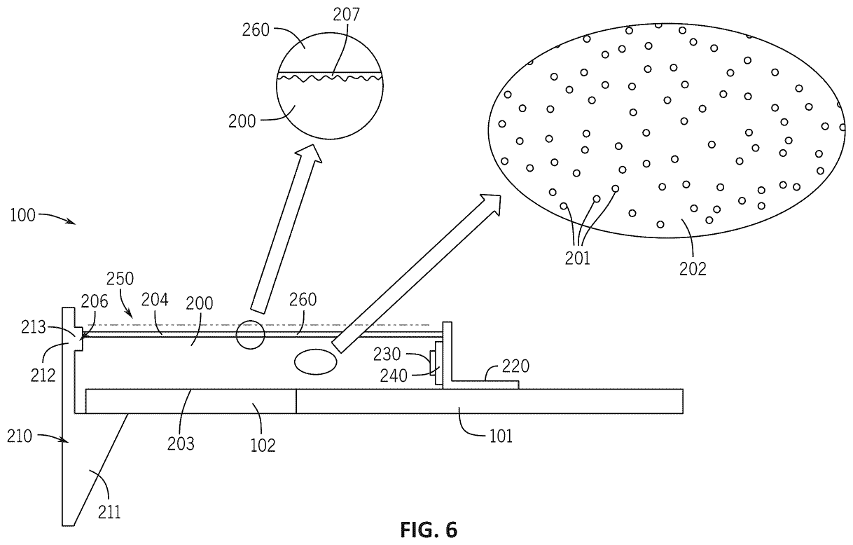

Referring to FIG. 6, a cross sectional view of the mirror assembly 100 of FIG. 1 taken along section line AA of FIG. 1 is illustrated. As illustrated in FIG. 6, the mirror assembly 100 may include a mirrored surface 101 (e.g., mirrored glass) and a frosted edge 102. The mirrored surface 101 and frosted edge 102 may collectively form a front surface of the mirror assembly 100. The mirrored surface 101 and the frosted edge 102 may be collectively referred to herein as the mirror. Further, as illustrated in FIG. 6, the mirror assembly 100 may include a diffuser 200, a frame 210, a bracket 220, a light source 230, a PCB 240, and a reflective surface 260. The diffuser 200, frame 210, bracket 220, light source 230, PCB 240, and reflective surface 260 may be collectively referred to herein as the light assembly 250.

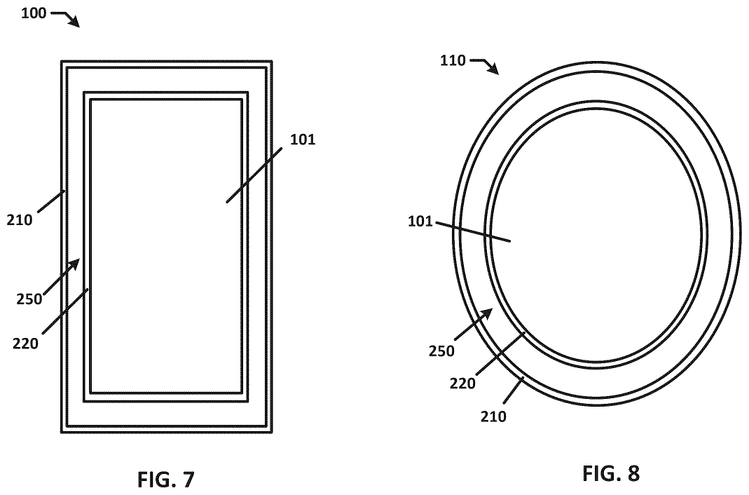

Although described with respect the mirror assembly 100 of FIG. 1, the light assembly 250 described herein may be included in any of the mirror assemblies 100, 110, 120, 130, 140 described herein. Specifically, the light assembly 250 may be disposed along (e.g., adjacent to, directly adjacent to) the frosted edge(s) 102 of any of the mirror assemblies 100, 110, 120, 130, 140 described herein. Referring to FIGS. 7 and 8, a rear view of the mirror assemblies 100 and 110 of FIGS. 1 and 2, respectively, are illustrated in accordance with examples of the present disclosure. Specifically, referring to FIGS. 6-8, the frame 210 may be disposed along an exterior boundary of the frosted edge 102, so as to abut the frosted edge 102, and the diffuser 200 may be disposed behind the frosted edge 102, so as to be directly behind and abutting the frosted edge 102. In other examples, the light assembly 250 may extend along a portion or portions of the frosted edges 102 of each of the mirror assemblies 100, 110, 120, 130, 140. As shown in FIGS. 7 and 8, the light assembly 250 may extend linearly (e.g., have a linear shape) along linear frosted edges 102 and the light assembly 250 may curve (e.g., have a curved shape) as it extends along curved frosted edges 102. In some examples, the frame 210 may be comprised of plastic or metal, for example, the frame 210 may be comprised of aluminum or aluminum alloy. However, the present disclosure is not limited thereto and the frame 210 may be comprised of any suitable material.

Returning to FIG. 6, the diffuser 200 may be disposed (e.g., directly) behind the frosted edge 102 and/or the mirrored surface 101. The diffuser 200 may be configured to refract or scatter (e.g., defuse, disperse) light generated by one or more light sources 230 included in the mirror assembly 100. The diffuser 200 may be configured to refract or scatter light generated by one or more light sources so that a brighter and more uniform illumination may be provided through the frosted edges 102 of the mirror assembly (e.g., toward a user).

The diffuser 200 may be comprised of a transparent or semi-transparent material configured refract or scatter light. Specifically, the diffuser 200 may be comprised of a material or materials having material properties (e.g., optical properties) that cause light traveling therethrough to refract or scatter. For example, a structure of the material or materials comprising the diffuser and/or irregularities in the material or materials comprising the diffuser 200 may cause light traveling therethrough to refract or scatter. In some examples, the diffuser 200 may be transparent (e.g., clear) and/or colorless.

In some examples, the diffuser 200 may include one or more additives 201. The one or more additives 201 may be, for example, particles suspended or disposed within the substrate 202. The one or more additives 201 may, for example, be configured to refract light. For example, as illustrated in FIG. 6, the diffuser 200 may include a plurality of additives 201 comprising refractive particles disposed in the substrate 202. In other examples, the diffuser 200 may not include additives 201 and may be comprised solely of the substrate 202. In some examples, the substrate 202 may be a transparent or semi-transparent plastic or acrylic material. The substrate 202 may be configured to refract or scatter light traveling therethrough. For example, material properties and/or irregularities in the material comprising the substrate may cause light traveling therethrough to refract or scatter. The additives 201 may be, for example, refractive particles comprising micro-glass beads or hollow glass microspheres. In some examples, the diffuser 200 may include less than 1% by weight of refractive particles. In some examples, the diffuser 200 may include less than 0.05% by weight of refractive particles.

In some examples, the diffuser 200 may include one or more additives 201 configured to reflect light. For example, as illustrated in FIG. 6, the diffuser 200 may include a plurality of additives 201 comprising reflective particles disposed in the substrate. The reflective particles disposed in the substrate 202 may be configured to reflect light (e.g., from the light source 230, traveling through the diffuser 200) creating a unique aesthetic or lighting effect visible through the frosted edge 102. The reflective particles may be, for example, gold flakes, silver flakes, gold spheres, silver spheres, and the like.

In some examples, the diffuser 200 may include one or more additives 201 configured to absorb light. For example, as illustrated in FIG. 6, the diffuser 200 may include a plurality of additives comprising absorbing particles disposed in the substrate 202. The absorbing particles may be for example, black particles (e.g., spheres, flakes) disposed in the substrate 202. The absorbing particles may absorb light generated by the light source 230 and/or traveling through the diffuser 200. The absorbing particles may absorb, for example, more than 85%, more than 90%, or more than 95% of light incident on the absorbing particles. In some examples, the absorbing particles may be configured to absorb light having a specific wavelength or wavelengths.

In some examples, the diffuser 200 may include two or more additives 201. For example, the diffuser 200 may include refractive particles and reflective particles.

In some examples, where the diffuser 200 includes additives 201 comprising refractive particles, the refractive particles may be configured to further refract or scatter light traveling through the diffuser 200. Specifically, light traveling through the diffuser 200 will refract at the multimedia interfaces between the substrate 202 and the refractive particles according to Snell's law of refraction. Snell's Law provides that when a light ray enters a different medium, its speed and wavelength change. As a result, the ray (1) bends towards the normal of the media interface when the ray's speed decreases in the new medium, or (2) bends away from the normal of the media interface when the ray's speed increases in the new medium. The angle of refraction depends on the indices of refraction of both media and may be determined using Equation 1:

$${n}_{1} sin ( Φ ) = {n}_{2} sin ( Ψ ) \qquad Eq . 1$$

where n₁ is the refractive index of the first medium (from which the ray travels), n₂ is the refractive index of the second medium (into which the ray travels), @ is the angle of incidence (the angle between the normal line to the interface boundary between the two media and the ray traveling through the first medium), and ψ is the angle of refraction (the angle between the normal line to the interface boundary and the ray traveling through the second medium).

Accordingly, light traveling through the diffuser 200 and incident on an additive 201 comprising a refractive particle will be refracted according to Snell's law as the light travels into the refractive particle through the multimedia interface between the substrate 202 and the refractive particle. Similarly, as light travels out of the refractive particles through the multimedia interface between the refractive particle and the substrate 202, the light will be refracted again, according to Snell's law. In some examples, including an additive 201 comprising refractive particles in the diffuser may obviate the need form abrasions and/or micro-indentations in the diffuser 200. Further, the refractive particles may refract or scatter light traveling through the diffuser 200 such that a more uniform and brighter light is provided through the frosted edge 102 than a light provided by a diffuser including only abrasions and/or micro-indentations.

According to some examples, when light traveling through the diffuser 200 is incident on an additive comprising a hollow glass microsphere, the light will be refracted not only at the multimedia interfaces between the substrate 202 and the hollow glass microsphere, but also at the multimedia interfaces between the glass microsphere and the hollow center as the light enters and exits the hollow center of the glass microsphere, thereby advantageously further refracting light incident on the hollow glass microsphere.

Referring to FIG. 6, the diffuser 200 may include a first surface 203 which abuts or contacts the frosted edge 102. As shown in FIG. 6, the first surface 203 may also abut or contact the mirrored surface 101. Further, as shown in FIG. 6, the diffuser 200 may surround or encapsulate a PCB 240 and/or a light source 230 attached or fixed to the bracket 220. As shown in FIG. 6, the PCB 240 and light source 230 mounted to the bracket 220 may face a frame 210 and/or a frosted edge 102 of the mirror assembly 100. As illustrated in FIG. 6, the diffuser 200 includes a second surface 204 opposite the first surface 203. As shown in FIG. 6, an inside end (e.g., inner perimeter) of the diffuser 200 may encapsulate or abut the light source 230 and/or PCB 240 and an outside end (e.g., outer perimeter) of the diffuser may abut the frame 210.

In some examples, the diffuser 200 may include a plurality of recesses 207. The plurality of recesses 207 may include, for example, one or more abrasions and or micro-indentations (e.g., micro-dots) formed therein and configured to further refract or scatter light. In some examples, plurality of recesses 207, for example, one or more abrasions and/or micro-indentations, may be formed in a diffuser 200 including an additive 201 comprising refractive particles or another additive. In other examples, one or more abrasions and/or micro indentations may be formed or included in a diffuser 200 that does not include refractive particles or another additive. In some examples, as shown in FIG. 6, the plurality of recesses 207, for example, the abrasions or micro-indentations may be formed on a second surface 204 of the diffuser 200 opposite the frosted edge 102 and/or the mirrored surface 101. Specifically, light may be refracted according to Snell's law as it is travels through the multimedia interface between the substrate 202 and air disposed in the abrasions and/or micro-indentations.

According to some examples of the present disclosure, in addition to refracting light, the refractive particles may create a unique aesthetic or light diffusion effect. Specifically, when light from the one or more light sources 230 is incident on (e.g., illuminates) one of the plurality of refractive particles, the refractive particle may glow. Accordingly, the plurality of refractive particles disposed in the diffuser may glow when illuminated, creating a unique aesthetic or light diffusion effect when viewed through the frosted edge 102.

As illustrated in FIG. 6, the mirror assembly 100 further includes a frame 210 disposed along an outer or exterior boundary of the frosted edge 102. In some examples, when a perimeter of the mirrored surface 101 is surrounded by frosted edge(s) 102, the frame 210 may surround or enclose an outer perimeter of the frosted edge(s) 102. In some examples, as described below in greater detail, the frame 210 may abut and/or be attached or fixed to the frosted edge 102.

In some examples, the frame 210 may include a flange portion 211 and a barrier portion 212. The flange portion 211 may extend in front of the mirrored surface 101 and the frosted edge 102 and may be configured to abut or contact a front of the frosted edge 102. In some examples, the flange portion 211 may be attached of fixed to the front of the frosted edge 102. For example, an adhesive or the like may be used to attach or fix the flange portion 211 to the frosted edge 102. In some examples, as illustrated in FIG. 6, the flange portion 211 may have a substantially triangular shape; however, the present disclosure is not limited thereto and in other examples, the flange portion 211 may have another shape, for example, a rectangular or linear shape.

The barrier portion 212 may extend or protrude (e.g., backwards) from the flange portion 211 behind the frosted edge 102 and mirrored surface 101. The barrier portion 211 may abut or contact an end of the diffuser 200. In some examples, as described below in more detail, the barrier portion 212 may be configured to retain or hold a liquid resinous material such that the diffuser 200 may be pour mold between the frame 210, frosted edge 102, mirrored surface 101, and bracket 220.

In some examples, the barrier portion 212 may include a locking protrusion (e.g., 213, 214) configured to control a position of the frame 210, frosted edge 102, and mirrored surface 101 (e.g., mirrored glass) relative to the diffuser 200. In some examples, a resinous material may be pour molded around the locking protrusion 213, 214 and locking protrusion 213, 214 may maintain a position of the frame 210, frosted edge 102, and mirrored surface 101 relative to the diffuser 200 when the resinous material has cured into the diffuser 200. The diffuser 200 may include a groove 206 having a shape corresponding to the locking protrusion 213, 214. In some examples, for example, when the diffuser 200 is not pour molded between the frame 210, frosted edge 102, mirrored surface 101, and bracket 220 the frame 210 and the diffuser 200 may be coupled to one another such that the locking protrusion 213, 214 is disposed in the groove 206. For example, the diffuser 200 may first be coupled to the frame 210, the frosted edge 102 may then be inserted between the frame 210 and the diffuser 200 and finally, the bracket 220 (e.g., including PCB 240 and light source 230) may be attached to a back of the mirrored surface 101. Accordingly, an interference fit connection may be used to couple the diffuser 200, the frame 210, the mirror (including the mirrored surface 101 and the frosted edge 102), and the frame 220.

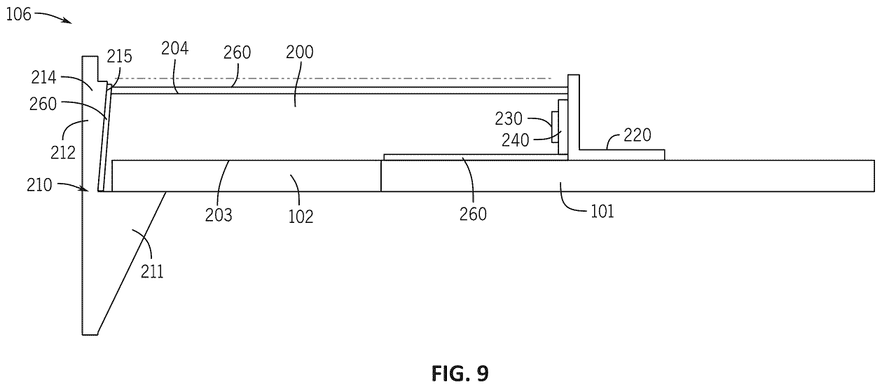

In some examples, as illustrated in FIG. 6, the locking protrusion 213, 214 may be a rectangular protrusion 213. In other examples, as illustrated in FIG. 9, the locking protrusion 213, 214 may be a triangular protrusion 214. The locking protrusion 213, 214 may be disposed behind the frosted edge 102 and/or the mirrored surface 101 of the mirror assembly 100.

As illustrated in FIG. 6, the mirror assembly 100 may further include a bracket 220. The bracket 220 may be (e.g., directly) attached or fixed to a back of the mirrored surface 101 (e.g., mirrored glass). As illustrated in FIG. 6, a PCB 240 and/or light source 230 may be coupled to the bracket 220. Specifically, the PCB 240 and/or light source 230 may be (e.g., directly) coupled to the bracket 220 so as to face the frame 210 and/or an exterior or outer boundary of the frosted edge 102. In some examples, the PCB 240 and/or the light source 230 may be (e.g., directly) coupled to the bracket 220 before the bracket 220 is coupled to the mirrored surface 101. In other examples, the PCB 240 and light source 230 may be coupled to the bracket 220 after the bracket 220 has been coupled to the mirrored surface 101. In some examples, the PCB 240 may be (e.g., directly) coupled to the bracket 220 and the light source 230 may be (e.g., directly) coupled to the PCB 240. In some examples, as described below in greater detail, the bracket 220 may be configured to retain or hold a liquid resinous material such that the diffuser 200 may be pour molded between the frame 210, frosted edge 102, mirrored surface 101, and bracket 220. In some examples, the bracket 220 may be comprised of plastic or metal. For example, the bracket 220 may be comprised of aluminum. However, the present disclosure is not limited thereto and the bracket 220 may be comprised of any suitable material.

As illustrated in FIG. 6, the mirror assembly 100 may further include a light source 230. In some examples, as illustrated in FIG. 6, the light source 230 may be a light emitting diode (LED) array. In some examples, the LED array may extend along a length (e.g., an entire length) of the frosted edge 102 and/or along a length (e.g., an entire length) of the diffuser 200. In some examples, the light source 230 may include two or more arrays (e.g., rows, columns) of LEDs extending along the length of the frosted edge(s) 102 and/or of the diffuser 200. In other examples, the light source 230 may be a single LED or a fluorescent, incandescent, or halogen light source. In some examples, the light source 230 may be present at or along only a portion of the frosted edge 102 and/or along only a portion of the diffuser 200. In some examples, when the light source 230 is an LED or LED array, the light source 230 may be configured to generate light having various different color temperatures. In some examples, a primary path of light generated by the light source may be perpendicular to a front surface of the frosted edge 102 and/or a front surface of the mirrored surface 101, such that the frosted edge 102 is indirectly lit by the light source 230.

In some examples, the mirror assembly 100 may further include a PCB 240. The PCB 240 may extend (e.g., directly) behind the light source 230 and be disposed behind the mirrored surface 101. The PCB 240 may be configured to provide power (e.g., electric current) and/or one or more control signals to the light source 230. In some examples, the PCB 240 may by flexible and may include a core comprised of a flexible polymer.

In some examples, the mirror assembly 100 may further include one or more white reflective surfaces 260. The one or more reflective surfaces 260 may be configured to reflect light, in order to maximize a quantity of light refracted through the diffuser 200 and emitted through the frosted edge 102. In some examples, the reflective surface 260 may be a highly reflective white coating (e.g., paint), for example, a 95% reflective white coating applied to a surface of the light assembly 250. In other examples, the reflective surface 260 may be a component comprised of a highly reflective white polyethylene terephthalate (PET) (95% reflective) material (e.g., attached or fixed to the light assembly 250). In some examples, the reflective surface 260 may be a component comprised of highly reflective white paper (e.g., attached or fixed to the light assembly 250). In some examples, as illustrated in FIG. 6, a reflective surface 260 may be (e.g., directly) applied or attached to a second surface 204 of the diffuser 200. Additionally, in some examples, as illustrated in FIG. 9, a reflective surface 260 may be applied or attached to a back of the mirrored surface 101 (e.g., between the bracket 220 and the frosted edge 102). Further, in some examples, where a locking protrusion 213, 214 of the frame 210 is a triangular protrusion 214, a reflective surface 260 may be applied or attached to a surface a surface (e.g., hypotenuse 215) of the triangular protrusion 214. The reflective surface 260 applied or coupled to the triangular protrusion 214 may be configured to reflect light toward the frosted edge 102 of the mirror assembly 100.

Referring to FIG. 9, a cross sectional view of a mirror assembly 106 in accordance with another example of the present disclosure is illustrated. As noted above the mirror assembly 106 includes a frame 210 having a triangular locking protrusion 214. Further, as noted above the mirror assembly 106 includes a reflective surface 260 disposed on a surface, for example, the hypotenuse 215 of the triangular protrusion 214. The reflective surface 260 disposed on the triangular protrusion 214 may be configured to reflect light toward the frosted edge 102 of the mirror assembly 106 increasing the quantity and/or brightness of light emitted through the frosted edge 102. Additionally, as noted above, the mirror assembly 106 may include a reflective surface 260 disposed along a back of the mirrored surface 101 between the bracket 220 and the frosted edge 102.

Referring to FIG. 8, a cross sectional view of a mirror assembly 100 performing primary lighting in accordance with one example of the present disclosure is illustrated. As illustrated in FIG. 8, a primary output 270 of light may travel out of the front of the mirror assembly 100 through the frosted edge 102. The primary output 270 of light may travel toward a user, illuminating the user so that the user may perform various tasks (e.g., cosmetic, hygienic tasks). The primary output 270 of light may be referred to herein as task lighting.

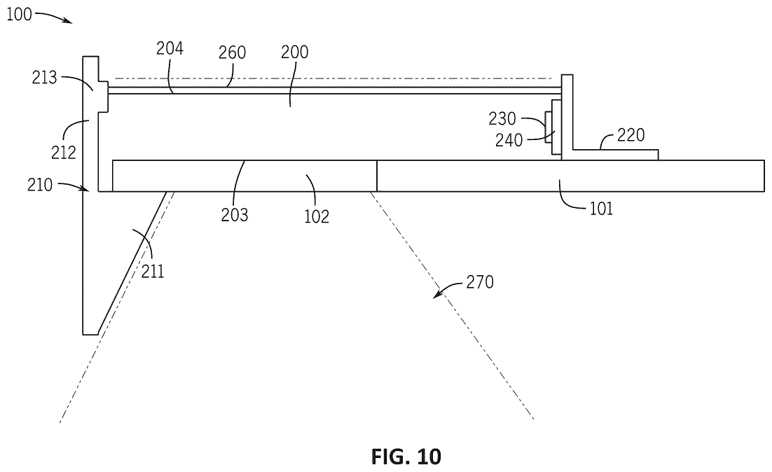

Referring to FIG. 10, light generated by the light source 230 may incident on and travel through the diffuser 200. As light travels through the substrate 202 of the diffuser 200, material properties of the substrate 202 may cause the light to refract or scatter. Further, light traveling through the diffuser 200 may refract as it travels through multimedia interfaces between the substrate 202 and refractive particles disposed or suspended in the substrate 202. Specifically, the light may refract as it travels into the refractive particle and again when the light travels out of the refractive particle. The light scattered or refracted by the diffuser 200 may travel through frosted edge 102 to the front of the mirror assembly 100. The light traveling through the frosted edge 102 may comprise the primary output 270 of light. In some examples, the mirror assembly 100 may further include one or more reflective surfaces 260. Light incident on the one or more reflective surface 260 may be reflected back into the diffuser 200 and may eventually travel through the frosted edge 102 (e.g., toward a user). The one or more reflective surfaces 260 may increase a quantity of light that travels through the frosted edge 102 and thus increase a quantity and/or brightness of the primary output 270 of light.

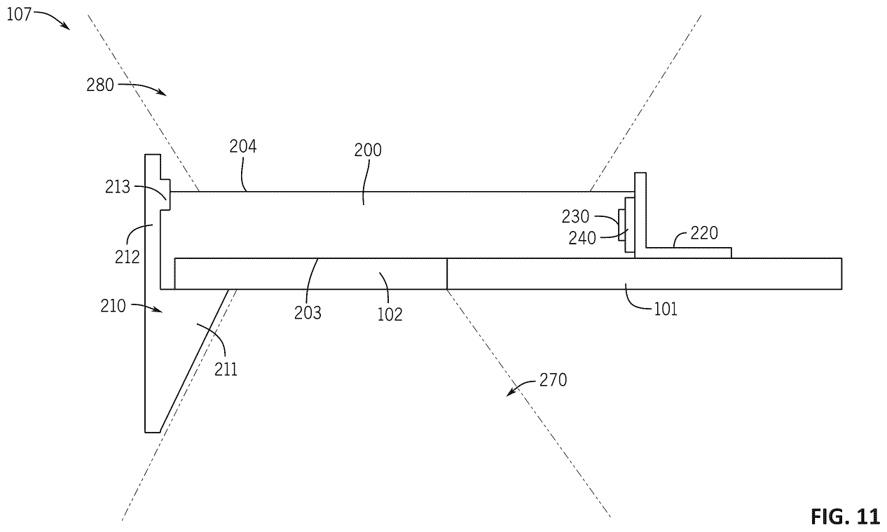

Referring to FIG. 11, a cross sectional view of a mirror assembly 107 performing primary lighting and secondary lighting in accordance with one example of the present disclosure is illustrated. In some examples, as illustrated in FIG. 11, a mirror assembly 107 according to an example of the present disclosure may be configured to emit or radiate light from both a front and a back of the mirror assembly 107. Specifically, as illustrated in FIG. 11, a primary output 270 of light may be emitted or radiated from a front of the mirror assembly 107 and a secondary output 280 of light may be emitted or radiated from a back of the mirror assembly 107. As described above, the primary output 270 of light may travel toward a user, illuminating the user and allowing the user to perform various tasks. The secondary output 280 may provide ambient lighting. Specifically, the secondary output may travel out the back of the mirror assembly 107 and may illuminate a wall or other surface disposed behind the mirror assembly 107. The secondary output 280 may be used as a night light or otherwise provide indirect lighting (e.g., to a room or space in which the mirror assembly 107 is disposed).

The primary output 270 out of the mirror assembly as described above with respect to FIG. 10. Further, as illustrated in FIG. 11, light scattered or refracted by the diffuser 200 may travel through the second surface 204 of the diffuser 200 and out the back of the mirror assembly 107. The light traveling through the second surface 204 of the diffuser 200 may comprised the secondary output 280 of light.

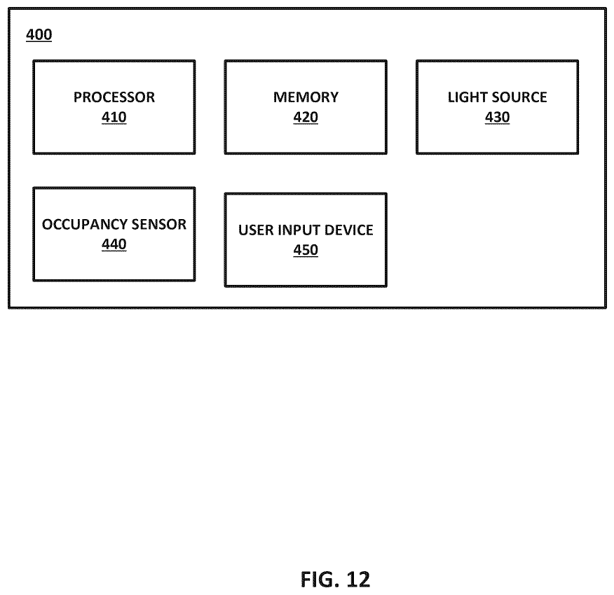

Referring to FIG. 12, a system 400 for controlling a mirror assembly 100, 110, 120, 130, 140 in accordance with one example of the present disclosure is illustrated. As illustrated in FIG. 11, the system 400 may include a processor 410, memory 420 and a light source 430. In some examples, the system 400 for controlling the mirror assembly 100, 110, 120, 130, 140 may further include an occupancy sensor 440 and/or a user input device 450.

The processor 410 and memory 420 may be configured to control any of the mirror assemblies 100, 110, 120, 130, 140 described herein. Specifically, the memory 420 may store one or more sets of rules or algorithms for controlling the light source 430 and the processor 410 may implement or execute the one or more sets of rules or algorithms. The light source 430 may be the same as the light source 230 described above with respect to FIG. 6.

In some examples, the system 400 for controlling a mirror assembly 100, 110, 120, 130, 140 may include an occupancy sensor 440. In some examples, the occupancy sensor 440 may be an optical sensor, for example, an infrared or microwave sensor. In other examples, another type of sensor, for example, an ultrasonic sensor may be user. In some examples, the occupancy sensor may be disposed behind the mirrored surface 101 of the mirror assembly 100, 110, 120, 130, 140. Specifically, in some examples, a portion of the mirrored surface 101 may include a two-way mirror or two-way glass such that the occupancy sensor 440 (e.g., an optical sensor) is able to sense or detect the presence of a user in front of the mirror assembly without a user seeing the occupancy sensor 440 or a change in the appearance of the mirrored surface 101 (e.g., between the portion of the mirrored surface include two-way glass and the rest of the mirrored surface 101).

The occupancy sensor 440 may be in communication with the processor 410 and/or the memory 420. Specifically, the occupancy sensor 440 may transmit or send sensor data to the processor 410 and/or memory 420. The processor 410 and/or memory 420 may be configured to receive the sensor data. The processor 410 may be configured to analyze the sensor data and control the light source 430 based at least in part on the sensor data. The sensor data may be indicative of a presence or lack thereof of a user in front of the mirror assembly 100, 110, 120, 130, 140. In some examples, the sensor data may be indicative of a distance between a user and the mirror assembly 100, 110, 120, 130, 140. The processor may control the light source 430 by sending one or more control signals and/or selectively providing power (e.g., electric current) to the light source 430. In some examples, the processor 410 may control a brightness of light generated by the light source by increasing power or electric current supplied to the light source 430.

In some examples, the processor 410 may control the light source 430 so as to turn the light source on when the sensor data indicates that a user is approaching or near the mirror assembly. In another example, the processor 410 may control the light source 430 so as to increase an intensity or brightness of light generated by the light source 430 when the sensor data indicates that a user is approaching or near the mirror assembly. In some examples, the processor 410 may control the light source 430 so as to turn off the light source 430 off or reduce the intensity or brightness of light generated by the light source 430 when the sensor data indicates that a user is departing from the mirror assembly or that a user is not proximate to the mirror assembly.

In some examples, the system 400 for controlling a mirror assembly 100, 110, 120, 130, 140 may further include a user input device 450. The user input device 450 may be configured to transmit one or more user input signals to the processor 410 in response to operation or actuation by a user. In some examples, the user input device 450 may be included in the mirror assembly 100, 110, 120, 130, 140, such that, for example, the user input device 450 is disposed along a side of the mirror assembly 100, 110, 120, 130, 140. The user input device 450 may include tactile (e.g., movable) buttons and/or one or more sensors (e.g., capacitive) configured to receive an input from a user when a user is proximate to the sensor. In other examples, the user input device 450 may not be physically attached to the mirror assembly 100, 110, 120, 130, 140 and may be, for example, a remote or mobile device configured to communicate wirelessly with the processor 410 and/or memory 420.

The processor 410 may be configured to receive the user input signals from the user input device 450 and may control the light source 430 in accordance with the various input signals. For example, the processor 410 may control the light source 430 so as to turn on (e.g., generate light), turn off (e.g., stop generating light), increase the intensity of light generated, decrease the intensity of light generated, and the like in response to user input signals. In some examples, the processor 410 may be configured to change the color temperature of light generated by the light source. In some examples, the primary output 270 of light and the secondary output 280 may be adjusted (e.g., turned on, turned off, color temperature, increase or decrease in light intensity) independently.

In some examples, in addition to receiving sensor data from the occupancy sensor 440 and/or user control signals from the user input device 450, the processor 410 may receive control signals from a wall switch (e.g., located in a room including the mirror assembly 100, 110, 120, 130, 140. In some examples, a control signal or control signals received from the wall switch may be configured to reset the mirror assembly 100, 110, 120, 130, 140 so as to generate light having a standard or preset intensity. For example, when the wall switch is toggled off and then back on, the processor 410 may control the light source 430 to generate light in a default mode (e.g., having a standard or predetermined intensity).

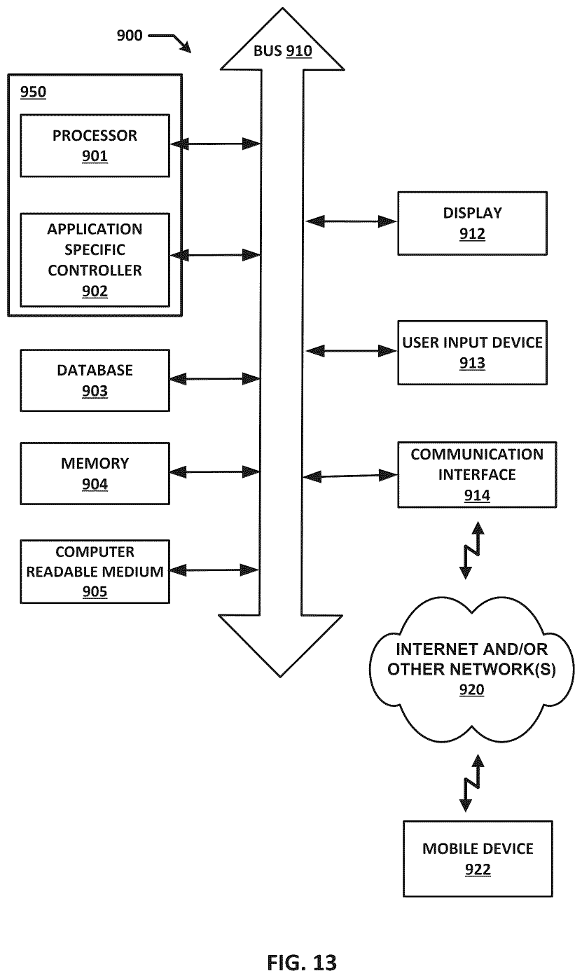

Referring to FIG. 13, an apparatus 900 for controlling a mirror assembly (e.g., 100, 110, 120, 130, 140) in accordance with one example of the present disclosure is illustrated. In some examples, the apparatus 900 may be implemented as the system 400 for controlling a mirror assembly. The apparatus 900 includes a bus 910 facilitating communication between a controller 950 that may be implemented by a processor 901 and/or application specific controller 902 and one or more components including a database 903, a memory 904, a computer readable medium 905, display 912, a user input device 913, and a communication interface 914. The processor 910 and memory 904 may be configured to perform the same functions as the processor 410 and memory 420 described above with respect to the system 400 for controlling a mirror assembly.

The contents of the database 903 may include, for example, one or more light settings (e.g., on, off, intensity or brightness, duration) associated with or corresponding to sensor data, user control signals, or control signals received by the processor 901. The memory 904 may be a volatile memory or a non-volatile memory. The memory 904 may include one or more read only memory (ROM), random access memory (RAM), a flash memory, an electronic erasable program read only memory (EEPROM), or other type of memory. The memory 904 may be removable from the apparatus 900, such as a secure digital (SD) memory card.

The memory 904 and/or the computer readable medium 905 may include a set of instructions that can be executed to cause the controller 950 to perform any one or more of the methods or computer-based functions disclosed herein. For example, the controller 950 may send one or more controller signals and/or electric current to the light source 230, 430 performing the various functionality described above with respect to the system 400 for controlling a mirror assembly.

A user may enter a new light setting (e.g., brightness, duration) using the display 912 and/or user input device 913. The display 912 may comprise a screen and the user input device 913 may comprise one or more buttons on the apparatus 900. In some examples, the display 912 and user input device 913 may comprise a touch sensitive surface (i.e., a touch screen). In some examples, the user input device 913 may include a microphone configured to receive one or more verbal or voice activation commands for controlling the mirror assembly.

The communication interface 914 may be connected to the network 920, which may be the internet. In some examples, the network 920 may be connected to one or more mobile devices 922. The one or more mobile devices may be configured to send a signal to the communication interface 914 via the network 920. For example, one or more mobile devices may send a signal to the communication interface to enter a new light setting (e.g., brightness, duration) or to control primary and/or secondary outputs 270, 280 of light (e.g., on, off, brightness or intensity).

The communication interface 914 may include any operable connection. An operable connection may be one in which signals, physical connections and/or logical communications may be sent and/or received. An operable connection may include a physical interface, an electrical interface, and/or a data interface. The communication interface 914 provides for wireless and/or wired communications in any known or later developed format.

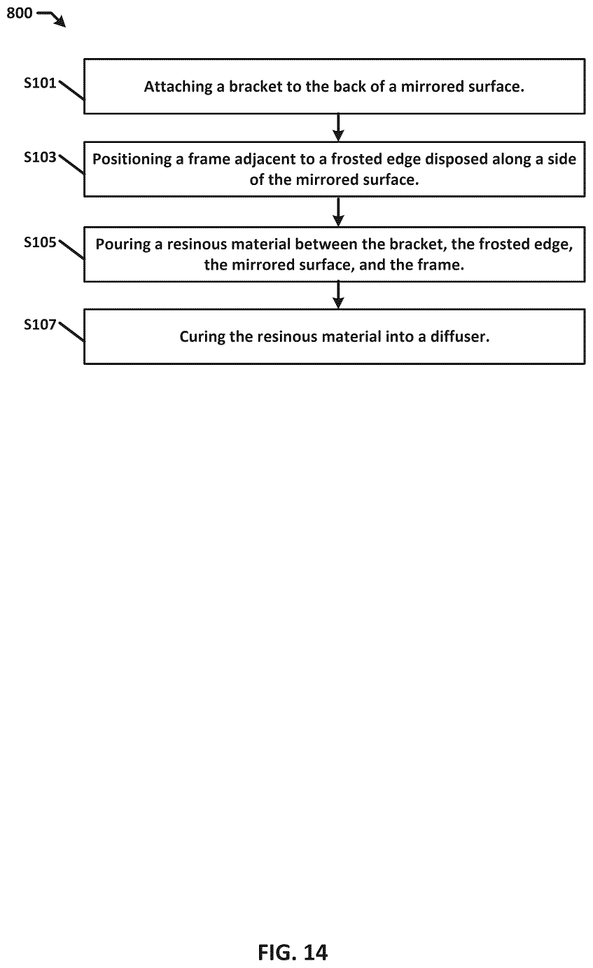

Referring to FIG. 14, a flow chart 800 for manufacturing a lighted mirror or mirror assembly according to one example of the present disclosure is illustrated. The flow chart 800 for manufacturing a lighted mirror may be used to manufacture any of lighted mirror assemblies 100, 110, 120, 130, 140 described herein. Additional, different, or fewer acts may be provided.

In a first act S101, a bracket 220 may be attached or fixed to the back of a mirrored surface 101 (e.g., mirrored glass). For example, the bracket 220 may be attached to a back of the mirrored surface 101 using an adhesive.

In some examples, the flow chart 800 for manufacturing a mirror assembly 100, 110, 120, 130, 140 may further include attaching or fixing a PCB 240 to the bracket 220. Additionally, in some examples, the flow chart 800 for manufacturing a mirror assembly 100, 110, 120, 130, 140 may further include attaching or fixing a light source 230 to a PCB 240 and/or the bracket 220. In some examples, the PCB 240 may be attached to the bracket 220 and/or the light source 230 may be attached to the PCB 240 and/or the bracket 220 using an adhesive. The PCB 240 may be attached to the bracket 220 and/or the light source 230 may be attached the PCB 240 and/or the bracket 220 before or after the bracket 220 is attached to the back of the mirrored surface 101.

In a second act S103, the frame 210 may be positioned along and/or adjacent to the frosted edge 102. For example, the frame 210 may be positioned along an outer boundary or outside edge of the frosted edge 102. In some examples, the frame 210 may abut or contact the frosted edge 102. Specifically, the flange portion 211 of the frame 210 may abut a front of the frosted edge 102 as illustrated in FIG. 6.

In some examples, the flow chart 800 for manufacturing a mirror assembly 100, 110, 120, 130, 140 may further include attaching or fixing the frame 210 to the frosted edge 102. Specifically, the flange portion 211 of the frame 210 may be attached or fixed to the frosted edge 102 as illustrated in FIG. 6. The flange portion 211 may be attached to the front of the frosted edge 102, for example, using an adhesive.

Referring generally to the first act S101 and the second act S103, the bracket 220 may be attached to the mirrored surface 101 (e.g., mirrored glass) and the frame 210 may be positioned next to the frosted edge 102 such that the frame 210, the frosted edge 102 and mirrored surface 101, and the bracket 220 form a mold (e.g., basin, container) in which a resinous material may be cast into a diffuser 200.

In some examples, the flow chart 800 for manufacturing a mirror assembly 100, 110, 120, 130, 140 may further include applying or (e.g., directly) coupling a white reflective surface to one or more of a back of the mirrored surface 101 and/or the frame 210, for example, a locking protrusion 213, 214 of the frame 210.

In some examples, the flow chart 800 for manufacturing a mirror assembly 100, 110, 120, 130, 140 may further include mixing a plurality of additives 201 into the resinous material. In some examples, the additives 201 may be refractive particles. In other examples, the additives may be reflective particles or absorbing particles. In some examples, two or more of refractive particles, absorbing particles, and absorbing particles may be mixed into the resinous material. Specifically, refractive particles comprising a plurality of micro-glass beads or hollow glass microspheres may be mixed into the resinous material before the resinous material is poured between the frame 210, the frosted edge 102, the mirrored surface 101, and the bracket 220. The resinous material may be in a liquid state when the refractive particles are mixed into the resinous material.

In a third act S105, resinous material may be poured between the frame 210, the frosted edge 102, the mirrored surface 101, and the bracket 220. At act S105, the resinous material may be in a liquid phase and comprise a mixture of two or more liquids. For example, one of the liquids may include the epoxy groups used and another liquid may be a hardener (e.g., an epoxy curing agent). The frame 210, frosted edge 102, mirrored surface 101, and bracket 220 may collectively form a mold into which the resinous material is poured. The frame 210, frosted edge 102, mirrored surface 101, and bracket 220 may be placed on their face such that an opening of the mold formed by the frame 210, frosted edge 102, mirrored surface 101, and bracket 220 is disposed at a top of mirror assembly. In act S105, the resinous material may be poured into the mold until the resinous material reaches a desired height corresponding to a second surface 204 of the diffuser 200. In some examples, as the resinous material is poured into the mold, the resinous material may surround or encapsulate the PCB 240 and/or light source 230 attached to the bracket 220. Additionally, as the resinous material is poured into the mold, the resinous material may flow around a locking protrusion 213, 214 included in the frame 210.

In some examples, instead of being poured between the frame 210, the frosted edge 102, the mirrored surface 101, and the bracket 220, the resinous material may be injected (e.g., injection molded) between the frame 210, frosted edge 102, mirrored surface 101, bracket 220, and a mold cover (e.g., disposed along and defining a second surface 204 of the diffuser 200). The frame 210, frosted edge 102, mirrored surface 101, bracket 220, and mold cover may define a cavity having a shape corresponding to a desired shape of the diffuser 200. In some examples, one or more additives may be mixed into the resinous material and injected with the resinous material.

In a fourth act S107, the resinous material may be cured into the diffuser 200. Specifically, the resinous material may be cured into a transparent or semitransparent diffuser 200. In some examples, the resinous material may be cured at an elevated temperature. In other examples, the ultraviolet (UV) light may be used to cure or decrease the time required to cure the resinous material into the diffuser 200.

In some examples, the flow chart 800 for manufacturing a mirror assembly 100, 110, 120, 130, 140 may further include applying or (e.g., directly) coupling a white reflective surface to a second surface 204 of the diffuser 200.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A mirror assembly comprising:
mirrored glass;
a frosted edge disposed along at least one side of the mirrored glass;
a diffuser disposed behind the frosted edge, the diffuser including an additive suspended in a substrate; and
a light source configured to generate light, wherein the additive is configured to refract, reflect, or absorb light generated by the light source and the light generated by the light source travels through the frosted edge.

2. The mirror assembly of claim 1, wherein the additive is refractive particles configured to refract light generated by the light source and the refracted light travels through the frosted edge.

3. The mirror assembly of claim 1, wherein the additive is refractive particles comprising micro-glass beads of hollow glass microspheres.

4. The mirror assembly of claim 1, further comprising:
a frame disposed along and abutting an outer edge of the frosted edge; and
a bracket coupled to a back of the mirrored glass,
wherein the diffuser is disposed between the frame and the bracket.

5. The mirror assembly of claim 4, wherein the frame includes a locking protrusion configured to control a position of the frame, the mirrored glass, and the frosted edge relative to the diffuser.

6. The mirror assembly of claim 5, wherein the locking protrusion includes a white reflective surface configured to reflect light toward the frosted edge.

7. The mirror assembly of claim 1, wherein the diffuser has a first surface abutting the frosted edge and a second surface opposite the first surface, and a white reflective surface is directly applied or coupled to the second surface.

8. The mirror assembly of claim 1, wherein the diffuser has a first surface abutting the frosted edge and a second surface opposite the first surface, and
Wherein light travels through the second surface and is configured to illuminate a surface behind the mirror assembly.

9. A mirror assembly comprising:
mirrored glass;
at least one frosted edge disposed along a side of the mirrored glass;
a diffuser disposed behind the at least one frosted edge, the diffuser including a plurality of refractive particles suspended in a substrate; and
a light source configured to generate light, wherein the plurality of refractive particles are configured to refract light generated by the light source and the refracted light travels through the at least one frosted edge.

10. The mirror assembly of claim 9, wherein the refractive particles are hollow glass microspheres.

11. The mirror assembly of claim 9, further comprising:
a frame disposed along an outer edge of the at least one frosted edge; and
a bracket behind the mirrored glass,
wherein the diffuser is disposed between the frame and the bracket.

12. The mirror assembly of claim 11, wherein the frame includes a locking protrusion configured to control a position of the frame and the mirrored glass relative to the diffuser.

13. The mirror assembly of claim 12, wherein the locking protrusion is triangular and includes a white reflective surface configured to reflect light toward the at least one frosted edge.

14. The mirror assembly of claim 11, wherein the light source is coupled to the bracket.

15. The mirror assembly of claim 9, wherein the at least one frosted edge is disposed along an entire perimeter of the mirrored glass.

16. The mirror assembly of claim 9, wherein the at least one frosted edge includes two frosted edges disposed on opposite side of the mirrored glass.

17. A mirror assembly comprising:
mirrored glass;
a frosted edge disposed along at least one side of the mirrored glass;
a frame disposed along an outer edge of the frosted edge;
a bracket coupled to a back of the mirrored glass;
a diffuser molded between the mirrored glass, the frame, and the bracket; and
a light source configured to generate light coupled to the bracket, wherein the diffuser is configured to refract light generated by the light source and the refracted light travels through the frosted edge.

18. The mirror assembly of claim 17, wherein the diffuser is comprised of a resinous material and includes a plurality of refractive particles suspended therein.

19. The mirror assembly of claim 17, wherein the frame includes a locking protrusion configured to control a position of the frame and the mirrored glass relative to the diffuser.

20. The mirror assembly of claim 19, wherein the locking protrusion is a triangular and includes a reflective white surface configured to reflect light toward the frosted edge.

21-29. (canceled)
